(19) United States
(12) Patent Application Publication
(10) Pub. No.: US 2014/0198970 A1
(43) Pub. Date: Jul. 17, 2014

(54) EDGE DETECTION DEVICE AND EDGE DETECTION METHOD

(71) Applicant: FUJITSU LIMITED, Kawasaki-shi (JP)

(72) Inventors: Hiroki SHIBUYA, Kawasaki (JP); Taizan KOBAYASHI, Kawasaki (JP); Katsuki SHIRAI, Yokohama (JP)

(73) Assignee: FUJITSU LIMITED, Kawasaki-shi (JP)

(21) Appl. No.: 14/082,380

(22) Filed: Nov. 18, 2013

(30) Foreign Application Priority Data
Jan. 11, 2013 (JP) 2013-003786

(51) Int. Cl. G06T 7/00

(52) U.S. Cl. CPC G06T 7/0004; G06T 7/0085
USPC 382/141

(57) ABSTRACT

An edge detection device includes: an image capturing mechanism configured to image-capture an edge of an optical joining block; and a control unit configured to control the image capturing mechanism, wherein the control unit: determines, based on image data of the edge, whether a plurality of regions included in the edge have a defective region including a defect or a non-defective region including no defect; determines whether or not first regions which are included in the plurality of regions and is determined to be the non-defective region satisfy a first condition; calculates a first straight line based on the first regions; and determines the first straight line as a position of the edge when the first regions has satisfied a first condition.

### CROSS-REFERENCE TO RELATED APPLICATION

This application is based upon and claims the benefit of priority of the prior Japanese Patent Application No. 2013-003786, filed on Jan. 11, 2013, the entire contents of which are incorporated herein by reference.

### FIELD

Embodiments discussed herein are related to an edge detection device and an edge detection method.

### BACKGROUND

In an optical module product such as an optical converter, an optical fiber cable is coupled to an optical module, and an optical waveguide is formed. In a process in which the optical fiber cable is coupled to the optical module, a ferrule is attached to the leading end of the optical fiber cable, and the end surface of the ferrule is coupled to an optical module side. On the optical module side to which the ferrule is joined, an optical joining block such as a glass block is used. The end surface of the ferrule and the end surface of the optical joining block are joined to each other with the positions of a core on a ferrule side and a core on an optical joining block aligned with each other, and an optical waveguide is formed that leads from the optical fiber cable to the optical module.

A related technique is disclosed in Japanese Laid-open Patent Publication No. 2008-116207.

### SUMMARY

According to one aspect of the embodiments, an edge detection device includes: an image capturing mechanism configured to image-capture an edge of an optical joining block; and a control unit configured to control the image capturing mechanism, wherein the control unit: determines, based on image data of the edge, whether a plurality of regions included in the edge have a defective region including a defect or a non-defective region including no defect; determines whether or not first regions which are included in the plurality of regions and is determined to be the non-defective region satisfy a first condition; calculates a first straight line based on the first regions; and determines the first straight line as a position of the edge when the first regions has satisfied a first condition.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an edge detection device for an optical joining block;

FIG. 2 illustrates an example of a joining portion of a glass block and a ferrule;

FIG. 3 illustrates an example of a processing of an edge detection device;

FIG. 4A and FIG. 4B illustrate an example of image data of a glass block end surface;

FIG. 5A and FIG. 5B illustrate an example of image data of a glass block end surface;

FIG. 6 illustrates an example of a region setting;

FIG. 7 illustrates an example of a brightness distribution of a region;

FIG. 8 illustrates an example of a differentiated waveform of a brightness distribution;

FIG. 9 illustrates an example of determination of a region to be adopted;

FIG. 10 illustrates an example of determination of a region to be adopted;

FIG. 11 illustrates an example of determination of a region to be adopted;

FIG. 12 illustrates an example of determination of a region to be adopted;

FIG. 13 illustrates an example of determination of a region to be adopted;

FIG. 14 illustrates an example of selection of a straight line determination region;

FIG. 15 illustrates an example of selection of a straight line determination region;

FIG. 16 illustrates an example of selection of a straight line determination region; and

FIG. 17 illustrates an example of selection of a straight line determination region.

### DESCRIPTION OF EMBODIMENTS

In position alignment for the cores of a ferrule and an optical joining block, the positions of the end surfaces of the two are confirmed by a microscope, a television camera, or the like, and the two are joined to each other.

Methods for extracting an edge with respect to the outline of a measurement target object include a method for differentiating the brightness value of image-captured image data.

When a defect exists in the edge of an optical joining block end surface, it may be difficult to detect the correct position of the edge from image-captured image data.

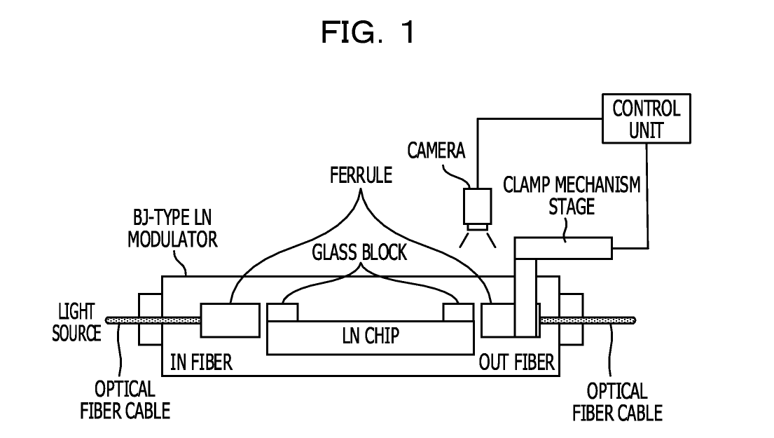

FIG. 1 illustrates an example of an edge detection device for an optical joining block. In the edge detection device for the optical joining block, illustrated in FIG. 1, the edge of a glass block end surface is detected as an example of the optical joining block. A glass block is joined to an LN chip in a BJ (Butt Joint)-type LN (LiNbO3) modulator serving as an optical module product.

In the LN modulator, the intensity or the frequency of light is changed owing to a Mach-Zehnder interference between two lights in two waveguides formed using an LN chip where Ti is diffused in a LiNbO3 substrate, and hence, information is converted into a signal. A traveling-wave electrode is attached to the waveguide of the LN chip, and by applying a voltage to the waveguide, the transmitted light intensity or the phase of light within the waveguide is changed, and the interference state of the Mach-Zehnder interference between two lights is controlled. In the waveguide of the LN modulator, it is desirable that a loss is low.

Light caused to enter from a light source through an optical fiber cable is input to the LN chip through a glass block joined to a ferrule used for an IN fiber. Light modulated in the LN chip is output to an optical fiber cable through a ferrule for an OUT fiber and joined to a glass block.

In the edge detection device, a camera is installed that image-captures a joining state between the glass block and the ferrule. Image data image-captured by the camera is input to a control unit. The ferrule coupled to the OUT-side fiber is held by a clamp capable of being positioned by a multiaxial stage mechanism. The control unit calculates the edge position of the glass block based on input image data, controls the stage mechanism with respect to the calculated position of an edge, and positions the edge of the ferrule at the edge position of the glass block, which is to serve as a joining position.

The image capturing of the glass block and the ferrule on an OUT side illustrated in FIG. 1 may also be performed on an IN side. The positioning of the ferrule on the IN side may also be contemporaneously performed.

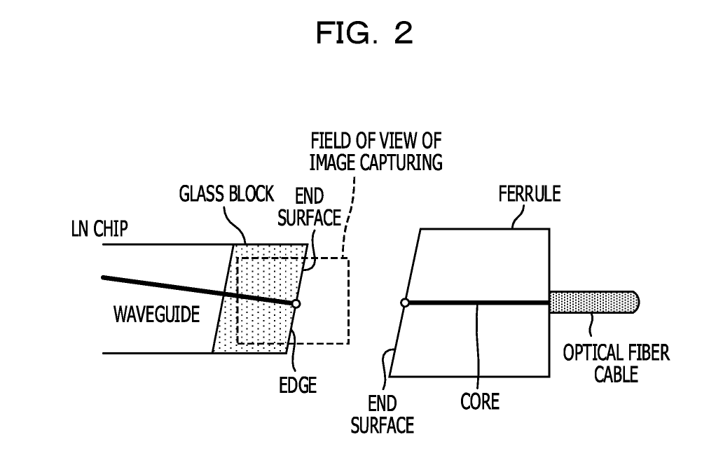

FIG. 2 illustrates an example of a joining portion of a glass block and a ferrule. In FIG. 2, the top views of the joining portions of the glass block and the ferrule in the LN modulator illustrated in FIG. 1 are illustrated. In FIG. 2, the waveguide provided from the LN chip through the glass block reaches the end surface of the glass block, indicated by a circle. A corner formed by the glass block end surface and a top surface facing the camera may correspond to the edge. When viewed from a top surface, an edge having no defect has a linear shape. The glass block end surface is cut diagonally as illustrated in the drawing, and faces the ferrule, and the waveguide may also be diagonally provided within the glass block. The circle illustrated in the end surface of the glass block becomes a joining point on a glass block side. In the ferrule attached to the optical fiber cable, a core to serve as a waveguide is provided, and a circle illustrated in the leading end of the core becomes a joining point on a ferrule side. An end surface on the ferrule side is also cut diagonally in accordance with the end surface on the glass block side, and joined to the glass block. The waveguide provided from the LN chip through the glass block is joined to the core in the joining point at a certain angle. The edge detection device controls the multiaxial stage mechanism illustrated in FIG. 1, and positions the ferrule so that the joining point on the ferrule side is aligned with the joining point of the glass block. An edge position in the end surface on the ferrule side is aligned with the edge position of the glass block, image-captured by the camera, and hence, the positioning of the ferrule is performed. The edge position of the glass block is expresses as a straight line, in the image data image-captured by the camera from the top surface. The straight line expressing the edge position is calculated, and hence, the position of the end surface of the glass block is measured.

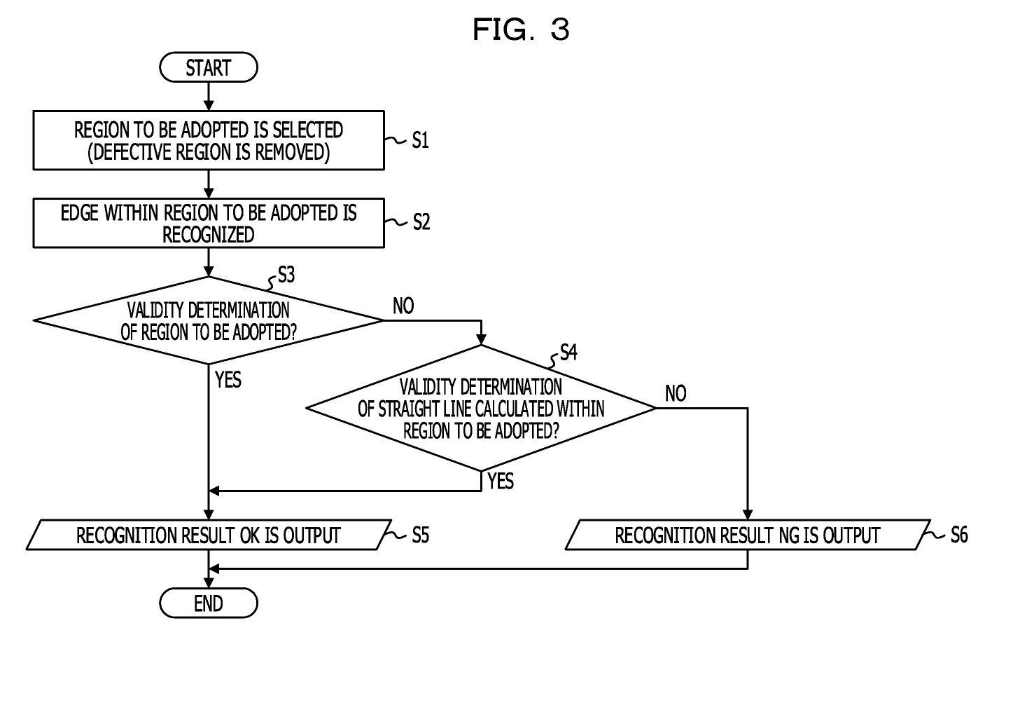

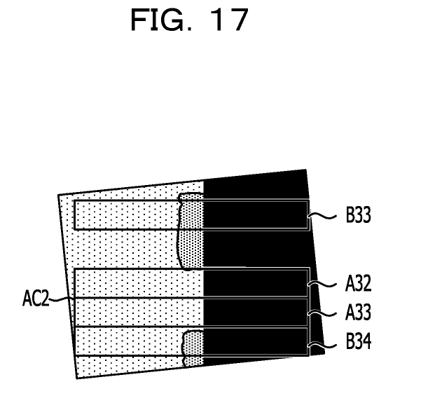

FIG. 3 illustrates an example of a processing of an edge detection device. In the drawing, the operation of the edge detection device for the optical joining block illustrated in FIG. 1 may be illustrated. The processing of an operation described in FIG. 17 may be executed in the control unit, as software that is executed in a computer.

In FIG. 3, the edge detection device performs the selection of a region (S1), and performs edge recognition within the region (S2).

[Acquisition of Image Data]

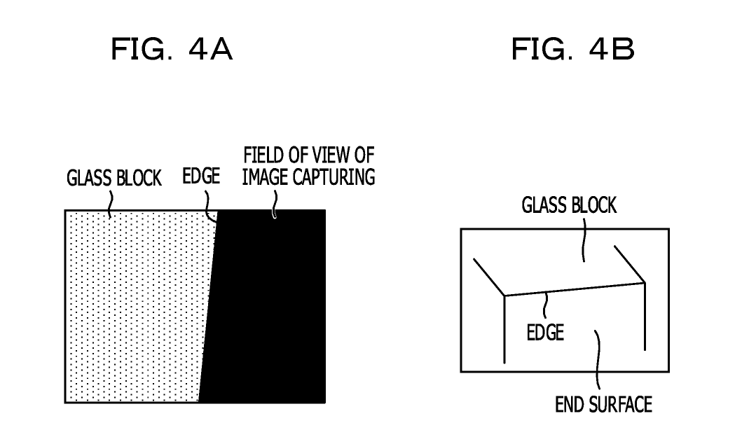

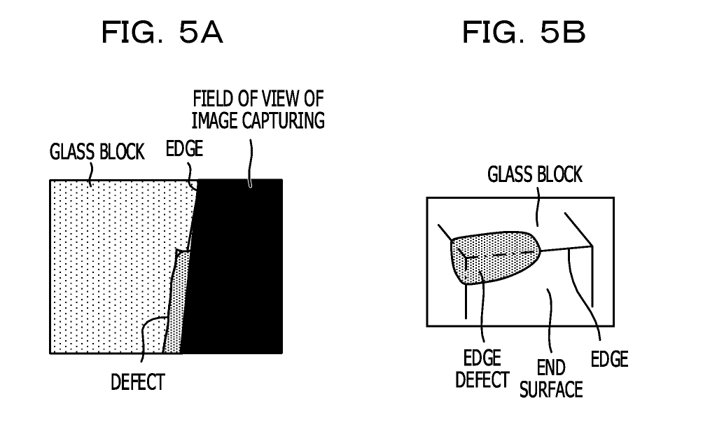

The acquisition of image data may be performed as preprocessing for the processing illustrated in FIG. 2. The camera image-captures the glass block end surface in the field of view of image capturing indicated by a dotted line in FIG. 2. FIG. 4A, FIG. 4B, FIG. 5A, and FIG. 5B illustrate examples of image data of a glass block end surface. In FIG. 4A, FIG. 4B, FIG. 5A, and FIG. 5B, the image data of the glass block end surface is illustrated that is acquired by the control unit from the camera.

FIG. 4A and FIG. 5A illustrate image data captured by the camera. FIG. 4B and FIG. 5B illustrate the perspective views of the states of the edge portion of the glass block. In FIG. 4A and FIG. 5A, owing to the reflected light of an illumination lamp, the glass block is image-captured with a high-luminosity white color with respect to a low-luminosity black portion serving as a background. Since the focus of the camera is put on the glass block top surface, a defective portion is image-captured with a low luminosity.

FIG. 4A and FIG. 4B illustrate images when no edge defect exists (non-defective). As illustrated in FIG. 4B, when no defect exists in the edge of the upper portion (camera side) of the glass block end surface, the edge of the glass block is image-captured in a linear fashion, in the image data illustrated in FIG. 4A.

FIG. 5A and FIG. 5B illustrate images when an edge defect exists. As illustrated in FIG. 5B, when a defect exists on the left side of the illustration of the drawing, in the edge of the upper portion (camera side) of the glass block end surface, a portion where the defect of the edge does not exist is image-captured in a linear fashion upward, and the defective portion of the edge is image-captured in a shape not forming a straight line with the non-defective portion, in the image data illustrated in FIG. 5A.

As illustrated in FIG. 5B, when only the upper side of the glass block end surface is defective and the defect does not reach the joining point in which the waveguide is formed, the glass block has no influence on an optical loss in joining with the ferrule. Therefore, the glass block is an optically non-defective product as a ferrule-adhesive material. In a case where a defective portion exists in the edge even if being the optically non-defective product, the image illustrated in FIG. 5A is image-captured as the image data image-captured from the top surface.

[Selection of Region (S1)]

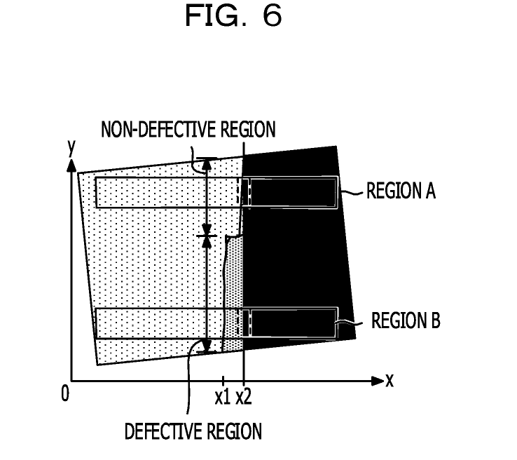

FIG. 6 illustrates an example of a region setting. In FIG. 6, the selection of regions including a defective portion and a non-defective portion is performed.

In FIG. 6, a control device rotates the image data image-captured by the camera so that the joining surface of the glass block becomes approximately parallel to a y-axis. A measurement location for a brightness distribution, provided in parallel to an x-axis in a certain y value, is referred to as a “region”. In FIG. 6, rectangles, which have a certain width in a y-axis direction and are parallel to the x-axis, may be selected as a region A and a region B.

While the rectangle having the certain width in a y direction is selected as the region, a line segment, which has no width in the y direction and is parallel to the x-axis, may also be selected as the region, for example.

As illustrated in FIG. 6, two regions may also be selected, and a plurality of regions, which are divided in the y-axis direction and located at a plurality of positions, may also be selected. When the number of regions is increased in the y direction, the resolution capability of a brightness distribution in the y-axis direction is improved. However, since the number of times of measuring a brightness increases, processing time may become large. In FIG. 6, the two regions may be selected. A position in the y-axis direction, at which a brightness value is measured in each region, may be, for example, the center of each region in the y direction, and may also be the minimum portion of each region in the y direction or the maximum portion thereof in the y direction. The measurement of the brightness value is performed in each selected region in an x-axis direction at certain intervals.

[Edge Recognition within Region (S2)]

The brightness distribution is measured in the selected region, and the recognition of an edge is performed. It is determined whether or not the edge of the glass block is defective within the selected region. A region where the edge is not defective may be adopted as a region used for calculating a straight line expressing an edge position. The region used for calculating a straight line may be referred to as an “adopted region”.

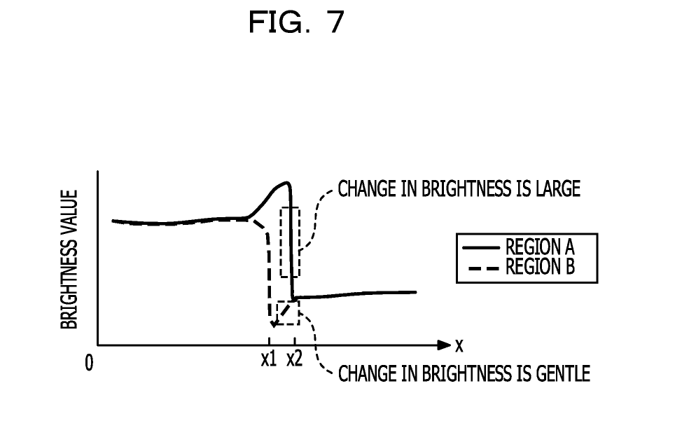

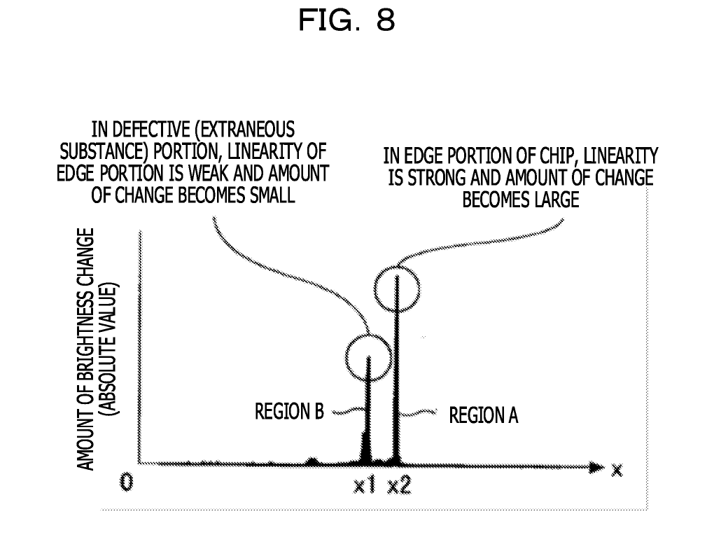

FIG. 7 illustrates an example of a brightness distribution of a region. FIG. 8 illustrates an example of a differentiated waveform of a brightness distribution. In FIG. 7, the brightness distributions of brightness values are graphically illustrated that have been measured in the x-axis direction with respect to the region A and the region B, which correspond to the regions selected in FIG. 6. The brightness values in the y-axis direction are measured in the center positions of the region A and the region B in the y-axis direction. For example, the measurement may be performed in the maximum y value of each region, and may also be performed in the minimum y value of each region. The brightness value may be measured at certain intervals in the x-axis direction with fixing a y value in each region.

In FIG. 6, a position at which a change from a high luminosity to a low luminosity occurs in the image data of the region B is defined as x1, and a position at which a change from a high luminosity to a low luminosity occurs in the region A is defined as x2. The x1 may correspond to the defective portion of the glass block edge illustrated in FIGS. 5A and 5B. The x2 may correspond to the non-defective portions of the edges illustrated in FIGS. 4A and 4B and FIGS. 5A and 5B. In the position of the x2 in the region B, surrounded by a dotted line, a small change in the luminosity occurs. This portion may be image data where the end surface of the glass block, in which the edge is defective, is captured by the camera from the top surface.

FIG. 7 illustrates the brightness distributions of the region A and the region B in FIGS. 5A and 5B. A graph of a solid line illustrated in FIG. 7 is a brightness distribution in an x direction, which expresses the brightness value of the region A. A graph of a dotted line is a brightness distribution in the x direction, which expresses the brightness value of the region B.

In the graph of the region A, since a border between the non-defective portion of the edge and the background is clear, the brightness value greatly changes at the position of the x2.

In the graph of the region B, the brightness greatly changes at the position of the x1. Since the value of the x1 is smaller than the value of the x2, it may be determined that the x2 exists in front of the edge of the glass block. Compared with the graph of the region A, a change in the brightness also gently falls from the near side of the x1. This indicates that the shape of the defective portion of the edge gently changes compared with the shape of the non-defective portion. At the position of the x2, the brightness gently increases.

FIG. 8 illustrates an example of a differentiated waveform of a brightness distribution. In FIG. 8, a differentiated waveform is illustrated where a brightness value is differentiated so as to obtain the amount of brightness change of the graph of the brightness distribution illustrated in FIG. 7. In FIG. 8, a peak expressing the magnitude of the amount of change in a brightness exists at each of the position of the x1 and the position of the x2. The peak of the x2 corresponding to the edge of the glass block is higher than the peak of the x1 corresponding to the edge defective portion. For example, the amount of change in the brightness of the x2 is larger.

As illustrated in FIG. 7 and FIG. 8, by determining the characteristic of an edge portion in the brightness distribution measured in the region, a difference between the defective portion of the edge and the non-defective portion thereof is determined and the recognition of the edge is performed. For example, a peak finally emerging in the x direction in FIG. 8 may be determined as the edge of the non-defective portion. Under the condition that a peak value is greater than or equal to a certain value, a peak may be determined as the edge of the non-defective portion. As illustrated in FIG. 7, when a gentle change in the brightness after a fall in the brightness is contained, it may be determined that the defective portion is contained.

A region where the edge is recognized as non-defective may be adopted as the adopted region.

[Validity Determination of Region to Be Adopted (S3)]

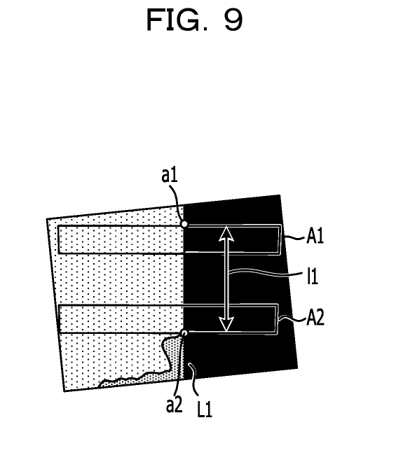

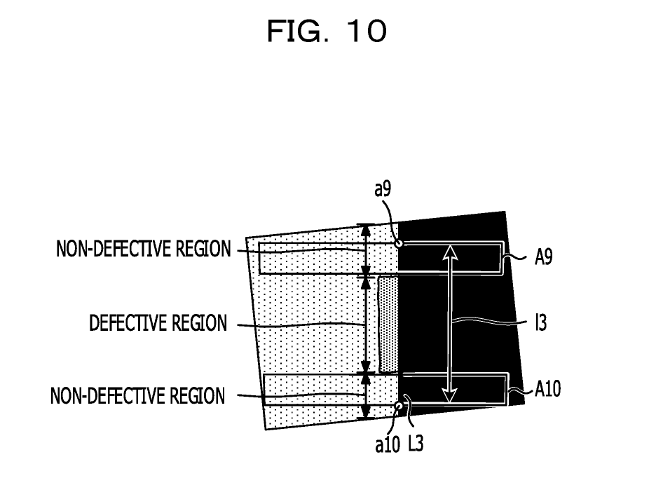

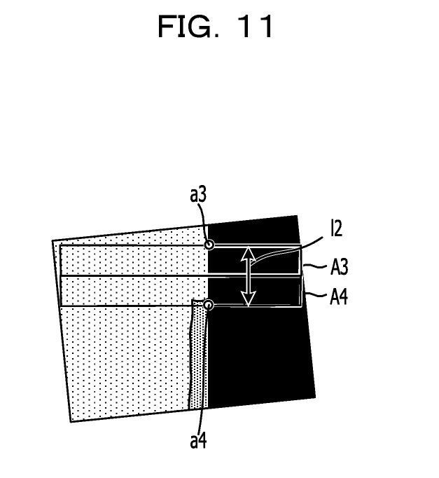

It is determined whether or not the region recognized, in the S2, as the adopted region is valid as a region used for calculating a straight line expressing an edge position. FIG. 9, FIG. 10, and FIG. 11 illustrate an example of a determination of an adopted region. For example, a first condition for determining whether or not the adopted region is valid is set. The straight line expressing the position of an edge is calculated from the coordinates of two points. Therefore, when a distance between the two points is short, even if the coordinate of the point is slightly displaced, the slope of the straight line is greatly changed. In the first condition, making a distance between the adopted regions as long as possible is determined so that the detection error of the edge position does not significantly influence the slope of a straight line. When the first condition is satisfied, it is determined that the adopted regions are valid (S3: YES), a straight line serving as a recognition result is calculated (S5), and the processing is terminated.

In FIG. 9, a case is illustrated where the first condition is satisfied and the adopted regions are determined to be valid. In FIG. 10, a case is illustrated where the first condition is not satisfied and the adopted regions are determined not to be valid.

In FIG. 9, a region A1 and a region A2 may be two regions, a distance between which is the largest among regions determined to be the adopted regions by the determination method illustrated in FIG. 6 to FIG. 8, from among a plurality of regions generated by dividing the edge of the glass block. When a distance between the regions is I1, the distance containing the widths of the individual regions in the y-axis direction, the I1 is obtained as a distance between a1 corresponding to the edge point of the region A1 and a2 corresponding to the edge point of the region A2. The a1 and the a2 are two edge points where a distance between the adopted regions in the y direction is the largest in the resolution capability of the divided regions in the y direction.

For example, when the first condition that the I1 is greater than or equal to a preliminarily set threshold value is satisfied, the control unit determines that the adopted regions based on the A1 and the A2 are valid.

In FIG. 10, a defective region exists between regions A9 and A10 which are determined as the adopted regions. While the regions A1 and A2 illustrated in FIG. 9 are continuous non-defective regions, a non-defective region is not continuous in FIG. 10. As an example of the second determination of the first condition, when a distance I3 between the a9 of the region A9 and the a10 of the region A10 is greater than or equal to the certain value, the adopted regions based on the regions A9 and A10, are determined to be valid. In FIG. 10, a case is described where one defective region exists between two non-defective regions. For example, when three or more non-defective regions exist, it may be determined whether the first condition is satisfied in a non-defective region farthest away.

FIG. 11 illustrates an example of a determination of an adopted region. In FIG. 11, a distance I2 between a3 and a4, which corresponds to a distance between the non-defective regions of regions A3 and A4 corresponding to the adopted regions, may be shorter than in FIG. 9 and FIG. 10. When the I2 is less than the certain value, it is assumed that the first condition is not satisfied, and the adopted regions based on the A3 and the A4, may be determined not to be valid.

The determination of the adopted regions, based on the first condition, may be performed based on the I1 to I3 serving as maximum values containing the widths of individual regions in the y direction. For example, a center-to-center distance between the individual regions may be defined as the target of the determination. The non-defective regions may not be defined as two regions but defined as three or more regions, and for example, the linearity of the edge positions of the three or more regions may be defined as the target of the determination based on the first condition.

When, using the first condition, the adopted regions have been determined to be valid, a straight line expressing the positions of edges is calculated in the adopted regions. For example, in FIG. 9, a straight line L1 is calculated based on the coordinates of the a1 of the region A1 and the a2 of the region A2. In FIG. 10, a straight line L3 is calculated based on the coordinates of the a9 of the region A9 and the a10 of the region A10. The coordinates of the non-defective regions, used for calculating the straight line, may also correspond to two points on edges becoming maxima in the y direction of the adopted regions, and may also correspond to, for example, halfway points between the individual adopted regions in the y direction on the edges. Using the coordinates of the three or more adopted regions, the straight line may be calculated.

The straight line calculated based on the adopted regions determined to be valid based on the first condition may be used for, for example, the position alignment of the ferrule in the multiaxial stage illustrated in FIG. 1, as the straight line expressing the edge positions (S5). When, based on the first condition, a non-defective region has been determined not to be valid as the adopted region, the validity of the straight line calculated based on the adopted region is determined (S4). A condition for determining whether or not the calculated straight line is valid may be defined as a second condition.

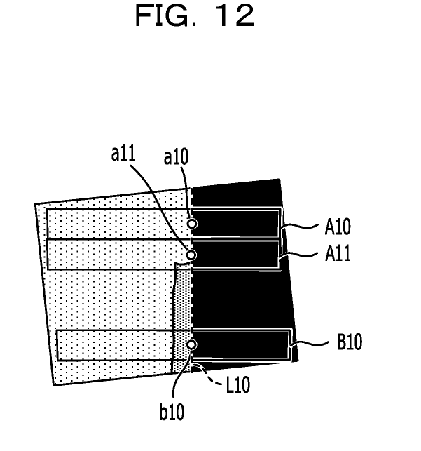

FIG. 12 illustrates an example of a determination of an adopted region. In FIG. 12, in the validity determination in (S3) of the adopted regions, the adopted regions A10 and A11 may be determined not to have a sufficient distance between the regions, and may be determined not to be valid. A straight line calculated based on the edge detection point a10 of the adopted region A10 and the edge detection point a11 of the adopted region A11 may be L10. Since the a10 and the a11 are not located well away from each other, when an error has occurred in the position measurement of the a10 or the a11, the slope of the straight line L10 turns out to be greatly deviated. Therefore, the validity of the calculated straight line L10 is determined.

The region of B10 may be an edge-damaged region, and as illustrated in FIG. 6, the coordinates b10 of an edge are calculated based on a gentle change in a brightness and the characteristic of the brightness value of a portion of a background portion. As the second condition, it is determined whether a distance between the calculated coordinates of the edge detection point b10 and the straight line L10 falls within a preliminarily set threshold value. The distance between the edge detection point b10 and the straight line L10 is obtained by calculating, for example, the length of a perpendicular line obtained by drawing a line perpendicular to the straight line L10 from the point b10. In the x-y coordinate illustrated in FIG. 5, by calculating a difference between x values at the same y value, the distance is obtained. In one edge detection point in a region B11, the validity of a straight line may be determined based on the second condition. For example, on the basis of comparison with edge detection points corresponding to multiple points in a plurality of regions, the determination of a straight line may also be performed. The second condition may also be preliminarily set in the control unit.

In FIG. 12, the edge detection point b10 and the straight line L10 satisfy the second condition and are located with a certain distance from each other, and it is determined that the straight line L10 is valid (S4: YES). The straight line L determined to be valid is used for the position alignment of the ferrule of the multiaxial stage as an expression expressing the edge position of the glass block (S5).

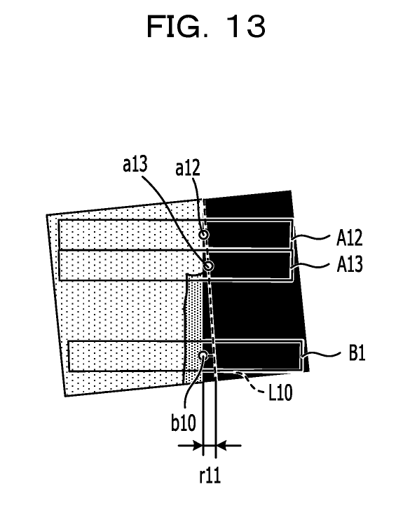

FIG. 13 illustrates an example of a determination of a adopted region. A glass block illustrated in FIG. 13 may be substantially the same as or similar to the glass block illustrated in FIG. 12. In an adopted region A12, a12 is detected as an edge detection point, and in a adopted region A13, a13 is detected. The error of r11 occurs between L11 calculated based on the a12 and the a13 and edge coordinates b11 measured in the region B11. In this case, the straight line L11 is determined not to be valid (S4: NO), and joining with the ferrule is discontinued that utilizes the glass block measured as a recognition result NG (S6). When the non-defective portion of the edge of the glass block is short, a calculated straight line may be different depending on a minimal scratch in or a substance attached to the edge of the edge detection point serving as a basis for the calculation of the straight line. Therefore, when the calculated straight line illustrated in FIG. 13 has been greatly displaced from an edge position, the ferrule may not be joined to the joining position.

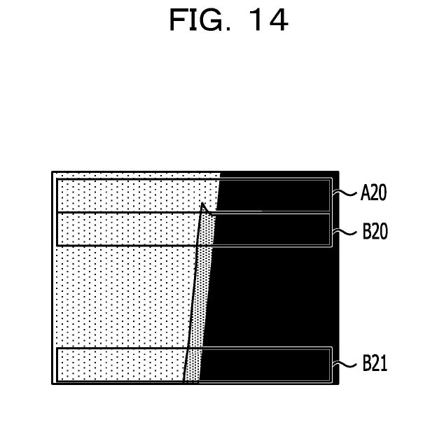

FIG. 14 to FIG. 17 illustrate an example of a selection of a straight line determination region.

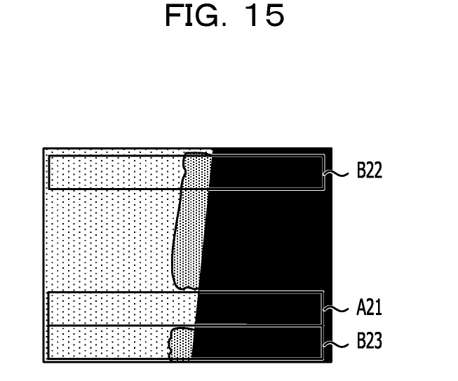

In FIG. 14, when B20 and B21 corresponding to defective regions are selectable as the straight line determination region with respect to a adopted region A20 used for recognizing a straight line, the B21, which is a region located farthest away from the region to be adopted A20, may be selected. Since, in the defective region, a change in a brightness at an edge detection point is small, a region as far away as possible is selected. In FIG. 15, when a region B23 and a region B22, which correspond to two straight line determination regions, are selectable with respect to a adopted region A21, the B22 located away from the A21 is defined as the straight line determination region.

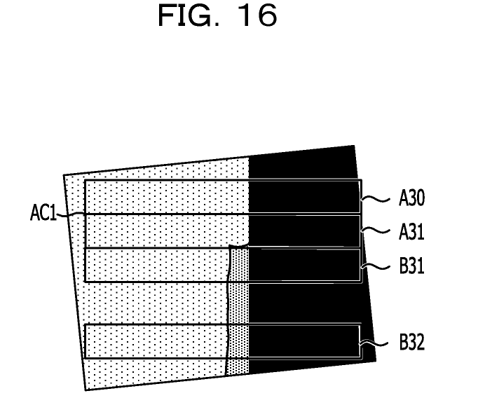

In FIG. 16 and FIG. 17, the selections of the straight line determination region are illustrated when there are a plurality of adopted regions. In FIG. 16, the adopted regions may be A30 and A31. When a region B31 and a region B32, which serve as two straight line determination regions, are selectable, a defective region located farthest away from the adopted regions is selected as the straight line determination region. Therefore, the region B32 located farthest away from a halfway point AC1 between the adopted regions A30 and A31 may be selected as the straight line determination region.

In FIG. 17, the adopted regions may be A32 and A33. When a region B33 and a region B34, which serve as two straight line determination regions, are selectable, the straight line determination region serving as a defective region located farthest away from the adopted regions is selected. Therefore, the region B33 located farthest away from a halfway point AC2 between the adopted regions A32 and A33 may be selected as the straight line determination region.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An edge detection device comprising:
an image capturing mechanism configured to image-capture an edge of an optical joining block; and
a control unit configured to control the image capturing mechanism,
wherein the control unit:
determines, based on image data of the edge, whether a plurality of regions included in the edge have a defective region including a defect or a non-defective region including no defect;
determines whether or not first regions which are included in the plurality of regions and is determined to be the non-defective region satisfy a first condition;
calculates a first straight line based on the first regions; and
determines the first straight line as a position of the edge when the first regions has satisfied a first condition.

2. The edge detection device according to claim 1, wherein the control unit:
detects an edge point of a second region which is included in the plurality of regions and is determined to be the defective region when the first regions have not satisfied the first condition;
determines whether the edge point satisfies a second condition with respect to the straight line; and
determines a second straight line based on the edge point as a position of the edge when the edge point has satisfied the second condition.

3. The edge detection device according to claim 1, wherein
the first condition is related to a distance between the first regions.

4. The edge detection device according to claim 1, wherein
the second condition is related to a distance between the edge point and the straight line.

5. The edge detection device according to claim 1, wherein
the control unit divides the edge into the plurality of regions.

6. The edge detection device according to claim 1, wherein
the control unit detects the edge point in the third region farthest away from the non-defective region, among the plural regions.

7. The edge detection device according to claim 1, further comprising:
a ferrule holding unit configured to hold a ferrule to be joined to the optical joining block; and
a positioning unit configured to position the ferrule holding unit,
wherein the control unit controls the positioning unit so that a position of the ferrule is aligned with a position of the edge.

8. An edge detection method comprising:
dividing an edge of an optical joining block into a plurality of regions;
determining, using a computer, whether the plurality of regions of the edge have a defective region including a defect or a non-defective region including no defect;
determining whether or not first regions which are included in the plurality of regions and is determined to be the non-defective region satisfy a first condition;
calculating a first straight line based on the first regions; and
determining the first straight line as a position of the edge when the edge point satisfies the second condition.

9. The edge detection method according to claim 8, further comprising:
detecting an edge point of a second region which is included in the plurality of regions and is determined to be the defective region when the first regions have not satisfied the first condition;
determining whether the edge point satisfies a second condition with respect to the straight line; and
determining a second straight line based on the edge point as a position of the edge when the edge point has satisfied the second condition.

10. The edge detection method according to claim 8, wherein
the first condition is related to a distance between the first regions.

11. The edge detection method according to claim 8, wherein
the second condition is related to a distance of the edge point from the straight line.

12. The edge detection method according to claim 8, further comprising:
aligning a position of a ferrule to be joined to the optical joining block, with a position of the edge.
